(19) United States
(12) Patent Application Publication
(10) Pub. No.: US 2026/0159170 A1
(43) Pub. Date: Jun. 11, 2026

(54) CRADLE DESIGN FOR HIGH VOLTAGE COMPONENT PROTECTION IN FRONT IMPACTS

(71) Applicant: FCA US LLC, Auburn Hills, MI (US)

(72) Inventors: Kalid Jaboo, Auburn Hills, MI (US); Krishnamurthy Hegde, Auburn Hills, MI (US); Kedar Panday, Auburn Hills, MI (US); Balaji Udhayakumar, Auburn Hills, MI (US); Vince M Seefried, Auburn Hills, MI (US)

(21) Appl. No.: 18/971,909

(22) Filed: Dec. 6, 2024

(51) Int. Cl. B62D 21/15; B62D 21/02

(52) U.S. Cl. CPC B62D 21/152; B62D 21/02

(57) ABSTRACT

An electrical vehicle front cradle has a plurality of cross beams and a pair of longitudinal beams, one on each side of the cross beams. Each longitudinal beam includes a first bulkhead to sustain higher load before deformation. A second bulkhead shifts deformation in the longitudinal beam rearwardly to provide a desired bending. A third bulkhead prevents lateral deformation of the longitudinal beam. A fourth bulkhead enhances downward deformation of the longitudinal beam. The first, second, third and fourth bulkheads are positioned along the longitudinal beam from one end to the other.

### FIELD

The present disclosure relates to electric vehicles and, more particularly, to a front cradle for an electric vehicle.

### BACKGROUND

This section provides background information related to the present disclosure which is not necessarily prior art.

During impacts in electric vehicles, damage may occur to high voltage components such as the electric drive motor and power inverter module. Mostly, this is due to the structural deformation of the vehicle that can result in high voltage isolation loss and prevent battery shutdown. The high voltage components need to be protected from damage that would affect high voltage isolation and shutdown. Because of packaging constraints, mainly the larger size High Voltage battery pack is packaged under the floor in Battery Electric Vehicles. Due to which, other high voltage components are typically packaged under the hood. The front of the vehicle undergoes different deformation patterns with various types of frontal impact scenarios. These deformations may cause damage to high voltage components.

In current vehicles, cradle deformation, especially of the longitudinal members or beams, may cause integrity issues to the electric drive motors and power inverter modules. Thus, it is important to control the deformation of the front cradle parts so that the integrity of these components remains.

The present disclosure provides a front cradle with a unique deformation pattern of the cradle where the electric drive motor and power inverter modules assembly is mounted. The present disclosure controls vertical deformation and reduces lateral movement of the cradle. This is achieved by positioning of bulkheads and beads on the longitudinal member of the cradle. The unique cradle deformation reduces intrusion and avoids electrical drive motor integrity issues.

The present disclosure provides a cradle enabler system solution to maintain critical high voltage components, such as electric drive motor, power inverter module and electric AC compressor intact during the impacts.

### SUMMARY

This section provides a general summary of the disclosure, and is not a comprehensive disclosure of its full scope or all of its features.

According to a first aspect of the disclosure, an electrical vehicle front cradle comprises a plurality of cross beams and a pair of longitudinal beams, one on each side of the cross beams. Each longitudinal beam includes a first, second, third and fourth bulkhead. The first bulkhead reinforces the longitudinal beam to increase beam load before deformation. The second bulkhead shifts deformation in the longitudinal beam rearward to provide a desired bending pattern. The third bulkhead prevents lateral deformation of the longitudinal beam. The fourth bulkhead causes downward formation of a longitudinal beam. The first, second, third and fourth bulkheads are positioned along the longitudinal beam from one end to the other. The first bulkhead has a body with a flange on one side. The second bulkhead has a pair of U-shaped portions coupled with one another where one end of the U-shape portion abuts a web of the other V-shape portion. The third bulkhead has a serpentine body with a C-shape cutout on one end and at least one projecting tab formed in from the body. The fourth bulkhead has an overall flattened U-shape with an elongated web. The fourth bulkhead is positioned adjacent the battery pack.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective schematic view of a front cradle.

FIG. 2 is a perspective schematic view of the cradle with the top part removed from the longitudinal beam.

FIG. 3 is an exploded view of the longitudinal beam.

FIG. 4 is a perspective view of the first bulkhead.

FIG. 5 is an elevation view of FIG. 4.

FIG. 6 is a perspective view of the second bulkhead.

FIG. 7 is an elevation view of FIG. 6.

FIG. 8 is a perspective view of the third bulkhead.

FIG. 9 is an elevation view of FIG. 8.

FIG. 10 is a perspective view of the fourth bulkhead.

FIG. 11 is an elevation view of FIG. 10.

FIG. 12 is a top plan view of the cradle.

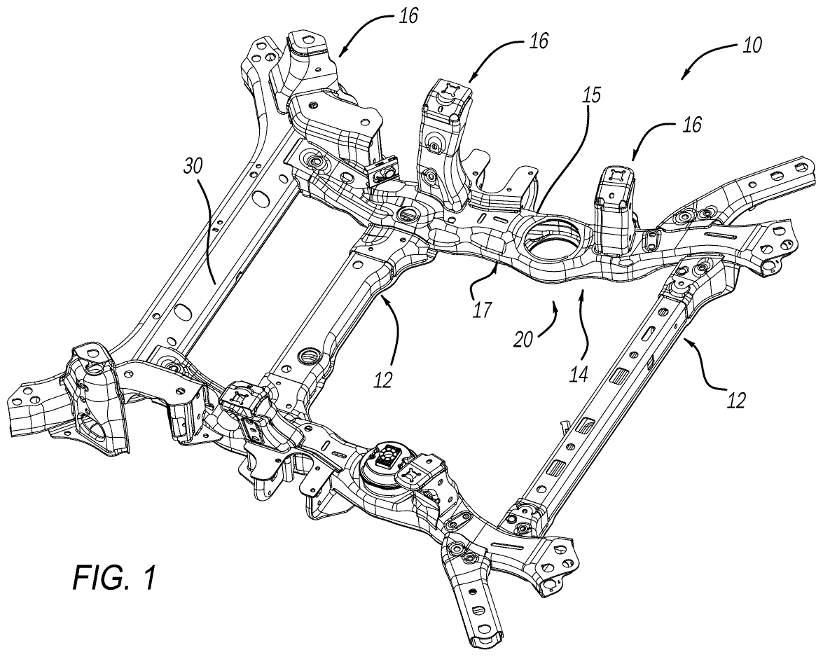

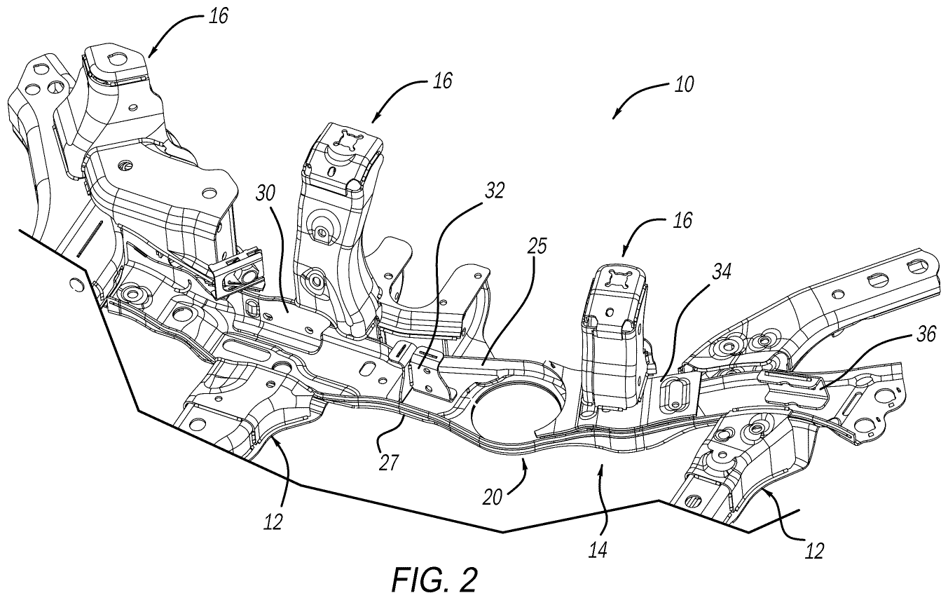

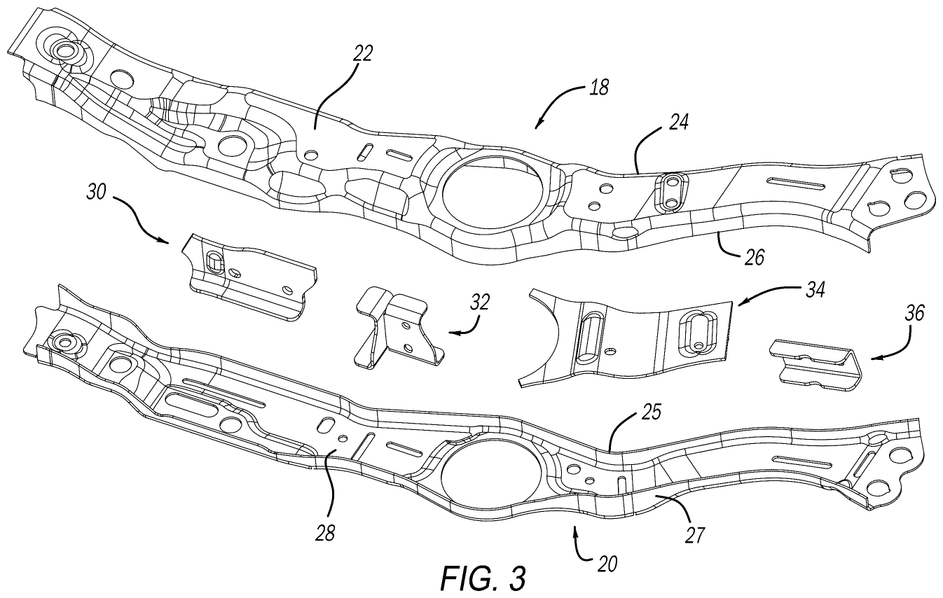

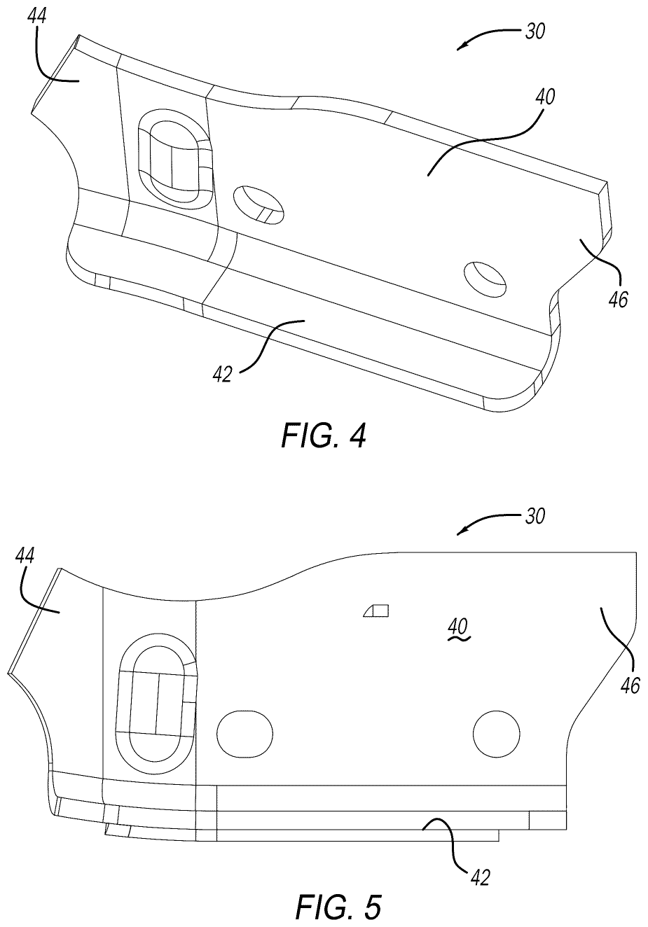

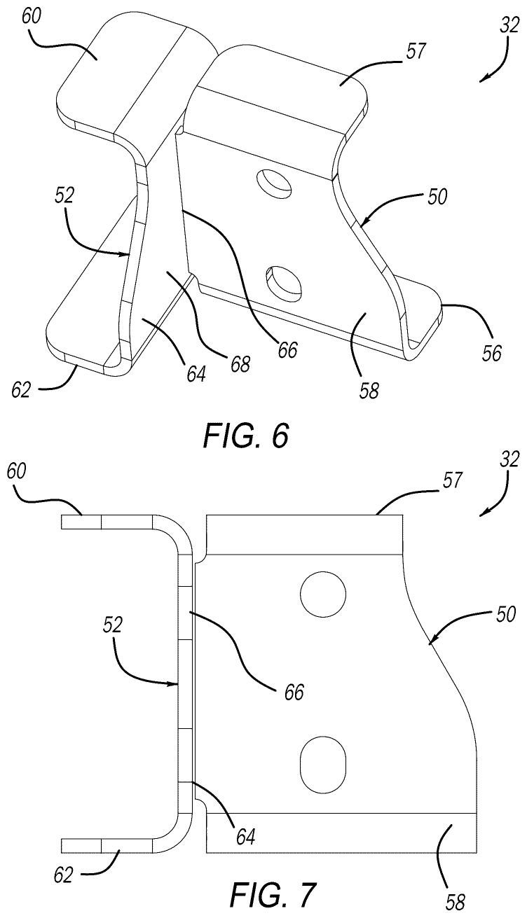

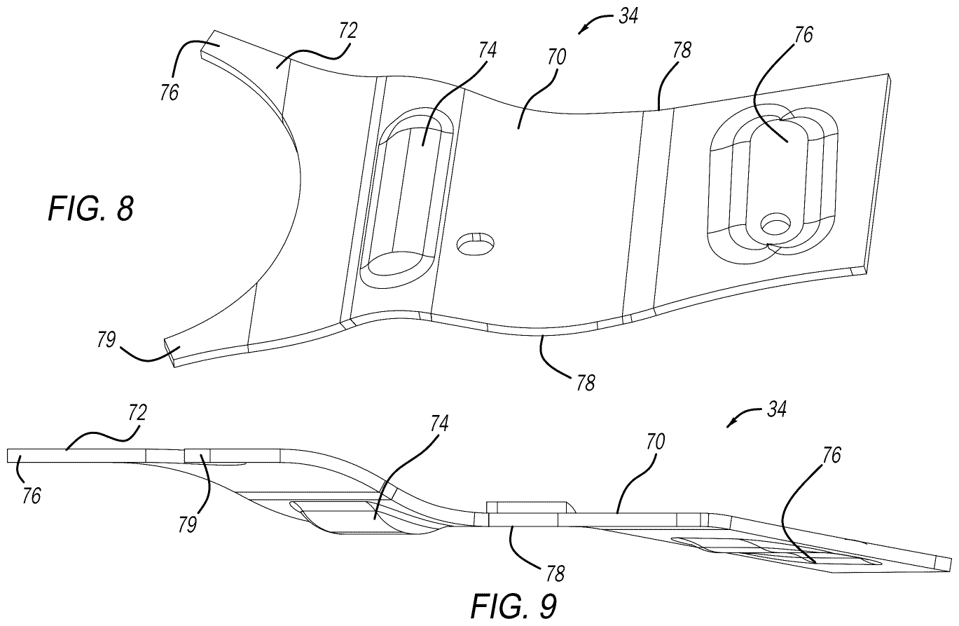

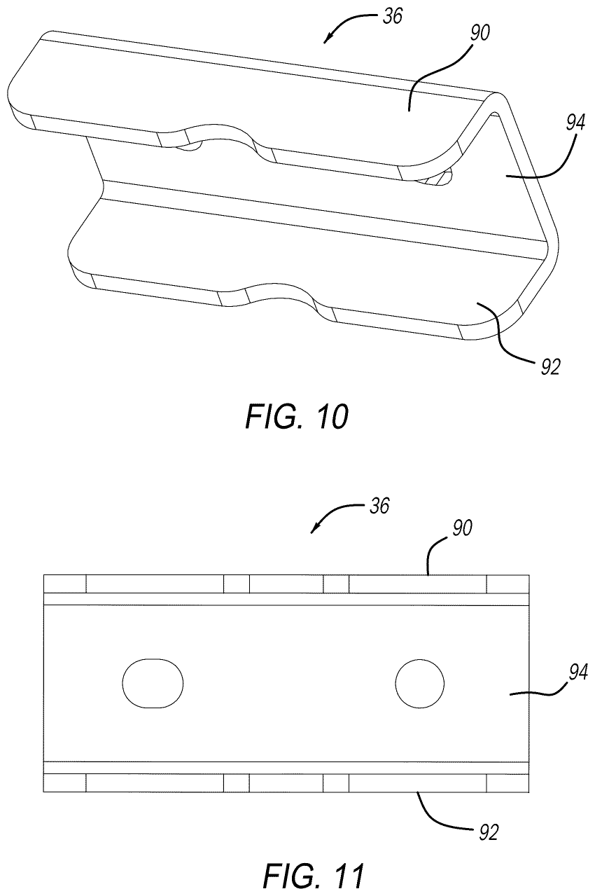

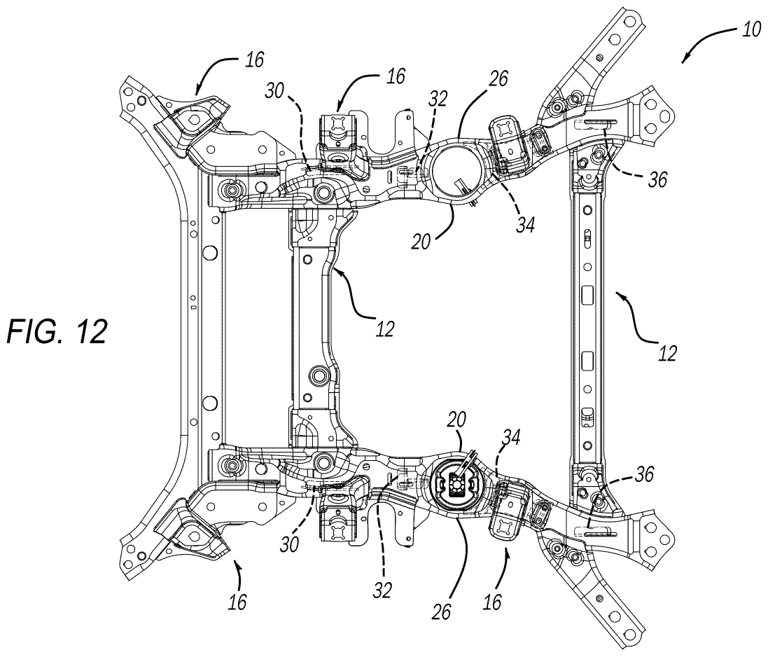

Corresponding reference numerals indicate corresponding parts throughout the several views of the drawings.

### DETAILED DESCRIPTION

Example embodiments will now be described more fully with reference to the accompanying drawings.

Turning to the figures, a front cradle for an electric vehicle is illustrated and designated with the reference numeral 10. The cradle includes a plurality of crossbeams 12 and a pair of longitudinal beams 14. Also, a plurality of motor mounts 16 extend from the cradle 10.

The longitudinal beams 14 are stamped parts including a top part 18 and a bottom part 20. The top part 18 includes a top wall 22 turning into sidewall portions 24 and 26. The bottom part 20 includes a bottom wall 28 with extending wall portions 26, 27 that mate with sidewall portions 24, 26 to form the beam sidewalls 15, 17.

A plurality of bulkheads 30-36 are positioned and secured in the longitudinal beam top and bottom parts 18, 20. The beams 14 include a first 30, second 32, third 34 and fourth 36 bulkhead positioned in the longitudinal beams 14 that extend from the front to the rear of the beams towards the battery pack.

The first bulkhead 30 includes a body 40 with a flange 42 extending from the body 40 to provide a L-shaped configuration. Both the body and flange are substantially planar elements. The body 40 includes a neck portion 44 and a tail 46. Both the neck portion 44 and the tail 46 extend from the body 40. The body 40 is positioned against the sidewall 15 and is either bolted or welded to it. The flange 42 is positioned on the bottom wall 28 and is arc welded to it.

The first bulkhead 30 is positioned towards the front of the beam 14 to restrict local deformation. Thus, this enables the cradle 10 fore member to take more load before deforming. Thus, this helps in reducing the load that is directed toward the high voltage components.

The second bulkhead 32 includes a pair of U-shaped members 50, 52. The U-shape member 50 includes legs 54, 56 as well as web 58. Likewise, the U-shape member 52 includes legs 60, 62 as well as the web 64. The U-shape members 50, 52 can have the same or different configurations. The edge 66 of the web 58 of U-shape member 50 abuts the body 68, near its center, of the web 64. Thus, the U-shape members 50, 52 are positioned such that their webs 58, 64 are transverse to one another. The second bulkhead 32 provides reinforcement strength in the beam 14.

The bulkhead 32 is positioned in between the sidewalls 15, 17. The flanges 56, 62 are secured, by bead welding, to the bottom wall 28. Additionally, the flanges 54, 56 are bead welded to the top wall 22 of the top part 18. The second bulkhead 32 enhances shifting of the deformation rearward to strategically provide the desired bending of the beam 14 during impact. This bending enhances and reduces the load on the electric drive motor.

The third bulkhead 34 has a body 70 with a serpentine configuration. The body 70 includes a C-shape cutout portion 72 and reinforcement ribs 74, 76. The C-shape cutout portion 72 includes arms 74, 76 which are positioned about an aperture in the beam 14 that receives a hydra mount. The body 70 is positioned in between the sidewall portions 24, 25 and 26, 27. The edges 78 of the body 70 may rest upon the wall portions 25, 27 of the bottom part 20 and be sandwiched by the wall portions 24, 26 of the top part 18. The edges 78 are bead welded or the like with the beam walls 15, 17. The third bulkhead 34 prevents lateral deformation of the longitudinal beam 14. This reduces the load, during impact, related to the electrical drive motor and maintains the high voltage integrity of the system.

The fourth bulkhead 36 has an overall U-shape with legs 90, 92 formed with web 94. The leg 92 is positioned on the bottom wall 28 as well as the leg 90 is positioned against the top wall 22. The legs 90, 92 are bead welded or the like with the top and bottom parts 18, 20. The fourth bulkhead 36 is positioned between the sidewalls 15, 17 to provide desired reinforcement. The bulkhead 36 is positioned near the end of the longitudinal beam 14 to enable the rear region of the beam 14 and cradle 10 to deform downward. Thus, the downward deformation reduces the chance of intrusion into the cab and also contains lateral movement. This provides protection to the electric drive motor.

The bulkhead parts 30-36 are stamped parts and are positioned within the hollow longitudinal beams 14 from a front of the beam to the rear of the beam 14. The bulkheads 30-36 enable the beam to meet front impact test modes such as flat frontal, SORB, annular impacts and deformable barriers. Thus, the desired bending of the longitudinal beams 14 at impact is provided by the present solution.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrical vehicle front cradle comprising:
a plurality of cross beams;
a pair of longitudinal beams, one on each side of the cross beams;
each longitudinal beam includes a first bulkhead for reinforcing the longitudinal beam for increasing beam loading before deformation;
a second bulkhead for shifting deformation in the longitudinal beam rearwardly to provide a desired bending;
a third bulkhead for preventing lateral deformation of the longitudinal beam;
a fourth bulkhead for enhancing downward deformation of the longitudinal beam; and
the first, second, third and fourth bulkheads positioned along the longitudinal beam from end to the other.

2. The electrical vehicle front cradle of claim 1, wherein the first bulkhead has a body with a flange on one side.

3. The electrical vehicle front cradle of claim 1, wherein the second bulkhead has two U-shaped members coupled with one another such that an end of one U-shape member abuts a web of the other U-shape member.

4. The electrical vehicle front cradle of claim 1, wherein the third bulkhead has a serpentine body with a C-shape cutout portion on one end.

5. The electrical vehicle front cradle of claim 1, wherein the fourth bulkhead has an overall U-shape with an elongated web.

6. The electrical vehicle front cradle of claim 1, wherein the fourth bulkhead is positioned adjacent the battery pack.

7. The electrical vehicle front cradle of claim 1, wherein the first bulkhead is secured to a sidewall of the beam.

8. The electrical vehicle front cradle of claim 1, wherein the second bulkhead is secured to a top and bottom wall of the beam.

9. The electrical vehicle front cradle of claim 1, wherein the third bulkhead is secured between sidewalls of a top and bottom part.

10. The electrical vehicle front cradle of claim 1, wherein the fourth bulkhead is secured to a top and bottom wall of the beam between sidewalls of the beam.

11. An electric vehicle including the front cradle comprising:
a plurality of cross beams;
a pair of longitudinal beams, one on each side of the cross beams;
each longitudinal beam includes a first bulkhead for reinforcing the longitudinal beam for increasing beam loading before deformation;
a second bulkhead for shifting deformation in the longitudinal beam rearwardly to provide a desired bending;
a third bulkhead for preventing lateral deformation of the longitudinal beam;
a fourth bulkhead for enhancing downward deformation of the longitudinal beam; and
the first, second, third and fourth bulkheads positioned along the longitudinal beam from end to the other.

12. The electrical vehicle of claim 11, wherein the first bulkhead has a body with a flange on one side.

13. The electrical vehicle of claim 11, wherein the second bulkhead has two U-shaped members coupled with one another such that an end of one U-shape member abuts a web of the other U-shape member.

14. The electrical vehicle of claim 11, wherein the third bulkhead has a serpentine body with a C-shape cutout portion on one end.

15. The electrical vehicle of claim 11, wherein the fourth bulkhead has an overall U-shape with an elongated web.

16. The electrical vehicle of claim 11, wherein the fourth bulkhead is positioned adjacent the battery pack.

17. The electrical vehicle of claim 11, wherein the first bulkhead is secured to a sidewall of the beam.

18. The electrical vehicle of claim 11, wherein the second bulkhead is secured to a top and bottom wall of the beam.

19. The electrical vehicle of claim 11, wherein the third bulkhead is secured between sidewalls of a top and bottom part.

20. The electrical vehicle of claim 11, wherein the fourth bulkhead is secured to a top and bottom wall of the beam between sidewalls of the beam.
